(19) United States
(12) Patent Application Publication
(10) Pub. No.: US 2007/0008967 A1
(43) Pub. Date: Jan. 11, 2007

(54) System and method for admission control of multicast downstream traffic in a wireless network

(75) Inventors: Ilan Bressler, Risholn Lezion (IL); Boris Ginzburg, Haifa (IL)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/167,007

(22) Filed: Jun. 24, 2005

(51) Int. Cl. H04B 7/00

(52) U.S. Cl. 370/390; 370/310

(57) ABSTRACT

Embodiments of System and Method for Admission Control of Multicast Downstream Traffic in a Wireless Network are generally described herein. Other embodiments may be described and claimed. In some embodiments, an access point may be restrained from over-reserving bandwidth for multicast streams.

### TECHNICAL FIELD

Some embodiments of the present invention pertain to wireless communication systems and some embodiments pertain to media access control in wireless local area networks. Some embodiments pertain to media access control in accordance with the with Institute of Electrical and Electronics Engineers (IEEE) 802.11e standard, draft D13, 2005.

### BACKGROUND

In a wireless local area network (WLAN) environment, an access point (AP) may serve as an intermediary between wireless communication stations and a wired network. Network data to be delivered to a particular wireless communication station traverses the network and reaches the access point, which in turn transmits the data to the particular wireless communication station.

An access point may extend service to many wireless communication stations at once. Conventionally, an access point transmits data to wireless communication stations by addressing each packet to an individual communication station. Packets of multicast traffic received by the access point for more than one communication station are also individually sent to each communication station. This consumes excessive bandwidth and reduces the bandwidth available to any one communication station.

Thus there are general needs for systems and methods that transmit multicast downstream traffic that use less bandwidth.

### BRIEF DESCRIPTION OF THE DRAWINGS

FIG. 1 illustrates a wireless communication network in accordance with some embodiments of the present invention;

FIG. 2 is a flow chart of an admission control procedure for multicast downstream traffic in accordance with some embodiments of the present invention;

FIG. 3 illustrates first and second wireless communication stations receiving downlink traffic;

FIG. 4 is a block diagram an access point in accordance with some embodiments of the present invention;

FIG. 5 illustrates a software stack suitable for use by an access point in accordance with some embodiments of the present invention;

FIG. 6 is a block diagram of a wireless communication station in accordance with some embodiments of the present invention;

FIG. 7A illustrates a software stack suitable for use by a wireless communication station in accordance with some embodiments of the present invention;

FIG. 7B illustrates a sequence of operations performed by a communication station and an access point for admission control of multicast downstream traffic in accordance with some embodiments of the present invention; and

FIG. 8 illustrates assemblage of the MAC address in accordance with some embodiments of the present invention.

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. Embodiments of the invention set forth in the claims encompass all available equivalents of those claims. Embodiments of the invention may be referred to, individually or collectively, herein by the term “invention” merely for convenience and without intending to limit the scope of this application to any single invention or inventive concept if more than one is in fact disclosed.

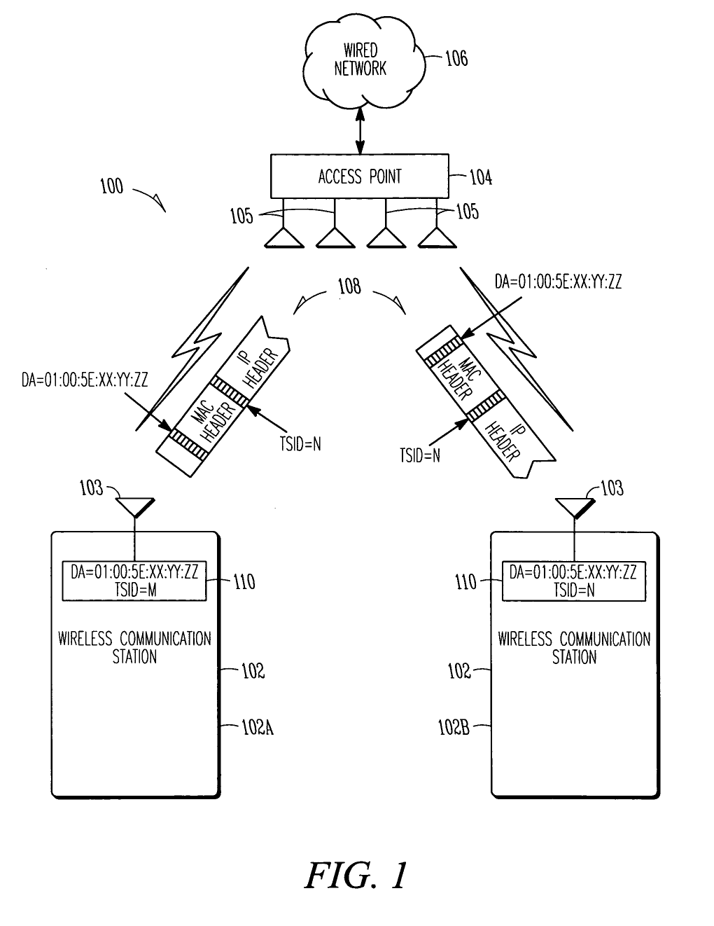

FIG. 1 illustrates a wireless communication network in accordance with some embodiments of the present invention. Wireless communication network 100 comprises access point (AP) 104 and one or more wireless communication stations (STA) 102. In network 100, access point 104 may serve as an intermediary between wireless communication stations 102 and wired network 106, such as the Internet. Data from network 106 to be delivered to a particular wireless communication station 102 traverses network 106 reaching access point 104 which transmits the data using one or more of antennas 105 to a particular wireless communication station 102 (i.e., either wireless communication station 102A or wireless communication station 102B). Although FIG. 1 depicts four antennas, access point 104 may include additional or fewer antennas. Wireless communication stations 102 may receive communications from access point 104 using one or more of antennas, generally shown as antennas 103.

In accordance with some embodiments of the present invention, access point 104 may be prevented from improperly over-reserving bandwidth for multicast streams. In some embodiments, a wireless communication station, such as wireless communication station 102A, may assign a traffic stream identifier to a multicast traffic stream. The traffic stream identifier may be used by access point 104 for transmissions of the multicast data stream to other requesting wireless communication stations without increase in transmission bandwidth. These embodiments are discussed in more detail below.

Access point may provide communication service to many wireless communication stations 102 and may employ a media access control (MAC) scheme to control access to the communication channel. Some conventional MAC schemes permit only one wireless communication station to transmit at a given time. In these situations, a conventional access point transmits data to several wireless communication stations by transmitting to each station during a different period of time, according to a MAC scheme. During such circumstances, each wireless communication station may observe a reduced downstream data rate, because many stations require a time period during which the access point transmits data to it. As the number of wireless communication stations served by an access point increases, downstream data rates generally decrease.

To address this issue, some MAC schemes provide quality-of-service (QoS) functionality. QoS functionality generally permits a particular wireless communication station to reserve a certain amount of bandwidth for communication of a given traffic stream from the access point to the particular wireless communication station. In some conventional MAC schemes, a wireless communication station may request that an access point identify certain downstream data frames as belonging to a “data stream.” For example, the user of a wireless communication station may wish to engage in an audio instant message session with a particular third party. Frames emanating from the third party destined for the wireless user and carrying the audio content of the instant message session are identified as belonging to the same data stream.

When a wireless communication station requests an access point to recognize particular data frames as belonging to a data stream, it may request the access point to essentially reserve a certain amount of bandwidth for the data stream. For example, in the context of the audio instant messaging example, the wireless communication station may request the access point to reserve 64 kilobits per second of bandwidth, to ensure that the frames carrying the audio content are received in a timely manner. If the access point has sufficient bandwidth, the data stream is admitted, and the access point may provide a bandwidth of 64 kilobits per second.

Unfortunately, conventional media-access control schemes do not appropriately addresses reservation of bandwidth for multicast data. For example, consider the following scenario. A user of first wireless communication station desires to receive an Internet radio station from an access point over a wireless link. As just described, the wireless communication station requests the access point to reserve sufficient bandwidth for the stream from the Internet radio station. Subsequently, a user of a second wireless communication station serviced by the same access point also desires to tune in the same Internet radio station. The second wireless communication station also requests the access point to reserve sufficient bandwidth. Thus, the access point reserves the bandwidth twice; once for the first wireless communication station, and once for the second wireless communication station. In this example, conventional MAC schemes reserves twice as much bandwidth as is necessary.

In accordance with some embodiments of the present invention, access point 104 may reserve the bandwidth only once. In the example of the addressing scheme used by an Internet radio station discussed above, access point 104 may only need to transmit each frame of audio content once. In these embodiments, both wireless communications stations 102A and 102B may receive the same transmitted frame. In these embodiments, discussed in more detail below, the transmitted frames are configured by access point 104 to allow receipt of multicast traffic by more than one communication station. Accordingly, no more bandwidth is required to provide a given multicast data stream to many wireless communication stations than to provide such a stream to one wireless communication station.

In FIG. 1, access point 104 is illustrated as transmitting multicast MAC frame 108. Although multicast MAC frame 108 is depicted twice, frame 108 is transmitted a single time by access point 104. The multicast MAC frame 108 is depicted twice to indicate that, upon transmission; frame 108 may propagate to each wireless communication station 102 and may be received by each wireless communication station 102.

In some embodiments, multicast MAC frame 108 may include a MAC header, followed by an Internet protocol (IP) header, application data, and a MAC trailer. In some embodiments, multicast MAC frame 108 may also include a user datagram protocol (UDP) header in the case of a multicast frame. For the sake of illustration, FIG. 1 depicts only the MAC header and IP header of multicast frame 108. In some embodiments, multicast MAC frame 108 may include information content pursuant to IEEE 802.11e, referenced below, although the scope of the invention is not limited in this respect.

In some embodiments, the MAC header of multicast MAC frame 108 may include a destination address (DA), which may be a 48 bit number that identifies the particular wireless communication station (e.g., either wireless communication station 102A or wireless communication station 102B) to which a frame is destined. The MAC header may also include a traffic stream identifier (TSID), which may be a 3-bit number from 8 to 15, although the scope of the invention is not limited in this respect. A traffic stream identifier may be used, among other reasons, to distinguish data streams destined for the same wireless communication station. In some embodiments, the MAC header of multicast MAC frame 108 may include information fields as described by IEEE 802.11e, referenced below, although the scope of the invention is not limited in this respect.

In some embodiments, each wireless communication station 102 may include front-end circuitry 110 that may include a wireless interface card and a driver. Front-end circuitry 110 may perform filtering to either prevent or allow a given frame to be processed by the associated wireless communication station. For example, each front end circuitry 110 may be associated with a unique receiver address (RA) of the associated wireless communication station. Front end circuitry 110 may receive each frame transmitted by access point 104, and may parse the frames to extract the destination address embedded therein. If the destination address does not match the address associated with front-end circuitry 110, the frame may be discarded. If, on the other hand, the addresses match, then the frame may be retained for further processing. Subsequently, the traffic stream identifier may be extracted. If the traffic stream identifier matches an identification number that one of wireless communication stations 102 has previously negotiated with access point 104, the frame may be passed to upper layers of software with a level of timeliness determined by the traffic stream identifier. If the traffic stream identifier does not match a previously negotiated identification number, the frame may be discarded.

In the context of receiving a multicast frame, upper layers of software may configure front-end circuitry 110 to retain and further process frames bearing a destination address that identifies a desired multicast data stream. For example, to “tune in” an Internet radio station, front-end circuitry 110 is configured to retain frames bearing a particular destination address associated with a particular audio stream from a particular Internet radio station. Each packet transmitted from the Internet radio station may have a destination address that identifies the audio stream, as opposed to identifying the receiving station.

In accordance with some embodiments of the present invention, front end circuitry 110 of both wireless communication stations (e.g., stations 102A and 102B) may be configured to retain MAC frames bearing the same destination address (e.g., 01:00:5E:XX:YY:ZZ) and traffic stream identifier (N). Therefore, access point 104 need only transmit a given MAC frame a single time. The frame may be received and processed by both wireless communication stations 102A and 102B. Since a single transmission serves both wireless communication stations 102A and 102B, access point 104 may reserve bandwidth for this stream but a single time.

Some embodiments of the present invention are applicable to time-sensitive applications operating on wireless communication stations 102A and 102B including, for example, streamed video applications, which may have time-sensitive packet transmission requirements. In some embodiments, the applications may include applications having QoS level requirements. QoS level requirements may include data rate requirements, error rate requirements and/or packet priority requirements. In some embodiments, the QoS level requirements may be based on the information content of the communications. The applications may also include less time-sensitive applications such as applications that communicate best-effort traffic as well as background traffic. Although some embodiments of the present invention are described reducing latency for time-sensitive applications, the scope of the invention is not limited in this respect, as some embodiments are equally applicable to almost any communication application operating on a transmitting or a receiving station. In some embodiments, time-sensitive applications may refer to any communication application having a packet-latency requirement.

In some embodiments, access point 104 and wireless communication stations 102 may be part of separate wireless communication devices that may communicate multicarrier communication signals, such as orthogonal frequency division multiplexed (OFDM) communication signals, or orthogonal frequency division multiple access (OFDMA) communication signals, although the scope of the invention is not limited in this respect. The multicarrier signals may be communicated over a multicarrier communication channel. The multicarrier communication channel may be within a predetermined frequency spectrum and may comprise a plurality of orthogonal subcarriers. In some embodiments, the orthogonal subcarriers may be closely spaced OFDM subcarriers. To help achieve orthogonality between the closely spaced subcarriers, each subcarrier may have an integer number of cycles within a symbol period, although the scope of the invention is not limited in this respect. In some other embodiments, access point 104 and communication stations 102 may communicate spread-spectrum signals, although the scope of the invention is not limited in this respect.

Although access point 104 is referred to herein as an access point, the scope of the invention is not limited in this respect. In some embodiments, access point 104 may be any managing wireless communication device. Examples of managing wireless communication devices may include wireless access points (APs), Wireless Fidelity (WiFi) communication stations, Worldwide Interoperability for Microwave Access (WiMax) communication stations, or broadband communication stations, although the scope of the invention is not limited in this respect as receiving station 102 may be almost any wireless communication device. In some embodiments, wireless communication stations 102 may be referred to as communication stations (STAs), such as WiFi, WiMax, or broadband communication stations, although the scope of the invention is not limited in this respect.

In some embodiments, the frequency spectrums for the communication signals communicated by access point 104 and communication stations 102 may comprise either a 5 GHz frequency spectrum or a 2.4 GHz frequency spectrum. In these embodiments, the 5 GHz frequency spectrum may include frequencies ranging from approximately 4.9 to 5.9 GHz, and the 2.4 GHz spectrum may include frequencies ranging from approximately 2.3 to 2.5 GHz, although the scope of the invention is not limited in this respect, as other frequency spectrums are also equally suitable. In some broadband and WiMax embodiments, the frequency spectrum for communications may comprise frequencies between 2 and 11 GHz, although the scope of the invention is not limited in this respect.

In some embodiments, access point 104 and communication stations 102 may communicate in accordance with specific communication standards, such as the Institute of Electrical and Electronics Engineers (IEEE) standards including IEEE 802.11(a), 802.11(b), 802.11(g), 802.11(h) and/or 802.11(n) standards for wireless local area networks (WLANs), although access point 104 and communication stations 102 may also be suitable to transmit and/or receive communications in accordance with other techniques. In some broadband and WiMax embodiments, access point 104 and communication stations 102 may transmit and receive broadband wireless communications in accordance with the IEEE 802.16(e) standards for wireless metropolitan area networks (WMANs). Some embodiments pertain to MAC in accordance the with the IEEE 802.11e standard, draft D13, 2005. For more information with respect to IEEE 802.11 and the IEEE 802.16 standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments/versions.

In some embodiments, communication stations 102 and/or access point 104 may be part of portable wireless communication devices, such as personal digital assistants (PDAs), laptop or portable computers with wireless communication capability, web tablets, wireless telephones, wireless headsets, pagers, instant messaging devices, digital cameras, access points, televisions or other device that may receive and/or transmit information wirelessly.

Antennas 103 and 105 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, access point 104 and communication station 102 may each use two or more antennas, although the scope of the invention is not limited in this respect. In some embodiments, instead of two or more antennas, a single antenna with multiple sub-apertures may be used.

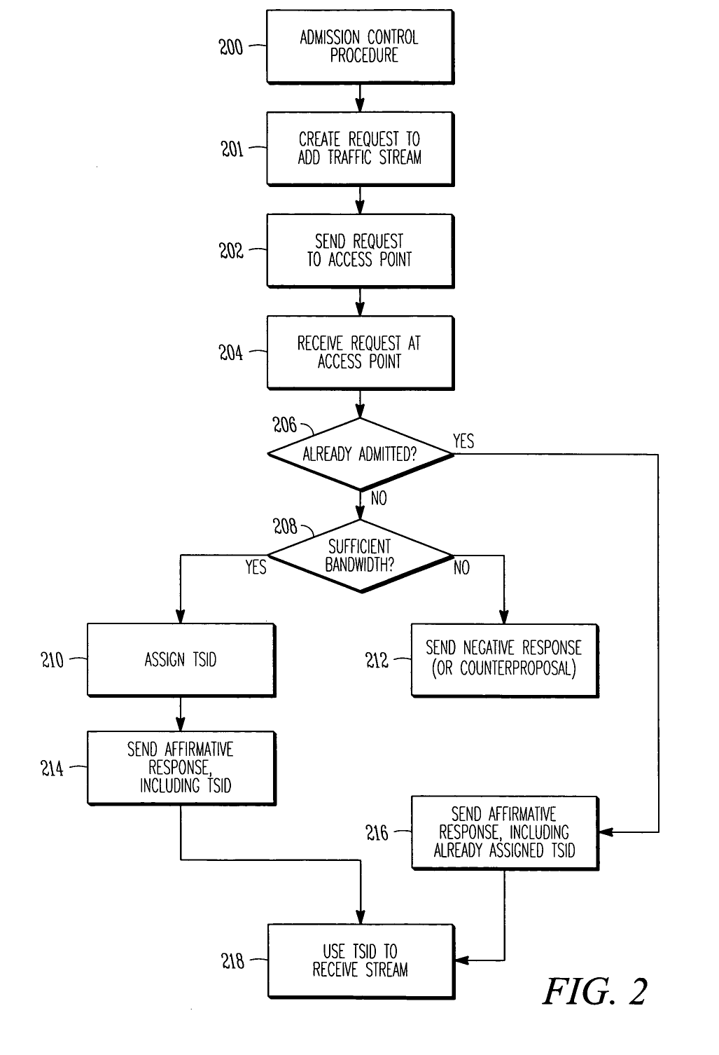

FIG. 2 is a flow chart of an admission control procedure for multicast downstream traffic in accordance with some embodiments of the present invention. Admission control procedure 200 may be used to admit multicast downstream traffic to more than one wireless communication station. Some operations of admission control procedure 200 may be performed by one or more of communication station 102 (FIG. 1), while other operations of procedure 200 may be performed by access point 104 (FIG. 1), although the scope of the invention is not limited in this respect.

Operation 201 comprises creating a request to add a traffic stream. Operation 201 may be performed by one of wireless communication stations 102 (FIG. 1). As part of operation 201, a user may invoke an application running on a wireless communication station to receive a multicast transmission. For example, a user may use an application to receive an Internet radio station.

Operation 202 comprises sending the request to add the traffic stream generated in operation 202 to an access point, such as access point 104 (FIG. 1). In some embodiments, the request may ask the access point to identify certain incoming frames as belonging to a data stream and to reserve a certain amount of bandwidth for servicing of frames belonging to the data stream. For example, an audio signal may require a bandwidth on the order of 64 kilobits per second. Therefore, in the context of this example, the wireless communication station may create a request that asks the access point to identify frames emanating from a particular Internet radio station as belonging to a data stream. The request may also ask to reserve enough time in its operations to ensure that it is able to transmit the data stream at a bandwidth of approximately 64 kilobits per second. In some embodiments, the request may include a description of the required data rate, a traffic stream identifier, and information that may inform the access point how to know whether an incoming frame belongs to the requested stream, although the scope of the invention is not limited in this respect. In some embodiments, the traffic stream identifier may be set to zero during operation 201 by the wireless communication devices.

In operation 204, the request is received by the access point. In operation 206, the access point may inquire into whether the access point is already identifying incoming data frames from the particular data stream (e.g., the Internet radio station) as belonging to a data stream that another wireless communication station may have already requested. If so, the access point may have already reserved bandwidth for this admitted data stream and may not need to reserve additional bandwidth. When operation 206 determines that the data stream is already admitted, operation 216 may be performed as described in detail below. When operation 206 determines that the data stream has not already been admitted, operation 208 is performed.

Operation 208 comprises determining by the access point whether sufficient available bandwidth is available to admit the requested data stream. In operation 208, the access point may consider bandwidth reserved for other data streams and other applications, although the scope of the invention is not limited in this respect. When operation 208 determines that sufficient bandwidth is available, operation 210 may be performed as described in detail below. When operation 208 determines that sufficient bandwidth is not available, operation 212 may be performed.

In operation 212 a response message may be sent to the requesting communication station indicating that the requested traffic stream will not be admitted. Alternatively, in some embodiments, an amount of bandwidth that can be dedicate to the requested traffic stream may be counter proposed, although the scope of the invention is not limited in this respect.

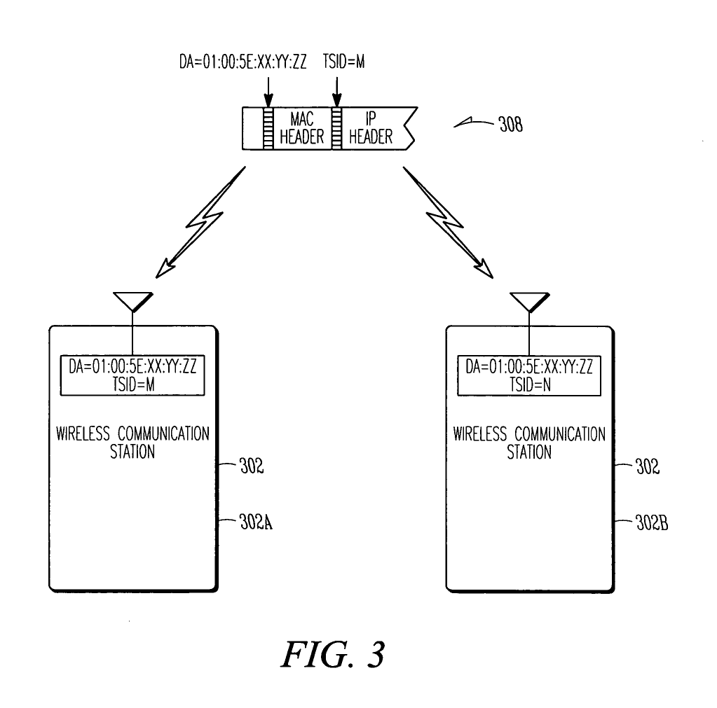

During operation 210, the access point may assign a traffic stream identifier (TSID) to the requested data stream. This is unlike some conventional techniques in which the wireless communication station assigns an identifier to a data stream. In accordance with these conventional techniques, the assigned traffic stream identifier may be communicated to the access point in an add traffic stream request. These conventional techniques make it difficult for more that one wireless communication station to receive downstream traffic when each wireless communication station independently assigns a traffic stream identifier to a multicast address, because two wireless communication stations will not likely assign the same identifier. An example of this conventional situation is illustrated in FIG. 3, described below.

FIG. 3 illustrates first and second wireless communication stations receiving downlink traffic with different traffic stream identifiers. Wireless communication station 302 may each subscribe to a multicast group whose frames bear the destination address illustrated as 01:00:5E:XX:YY:ZZ. First wireless communication station 302A may assign a traffic stream identifier of M to the stream, while second wireless communication station 302B may assign a traffic stream identifier of N to the stream. When an access point attempts to communicate a given frame of multicast data to wireless communication stations 302A and 302B in a single transmission, the access point chooses to use either M or N as the traffic stream identifier. As illustrated in FIG. 3, downstream frame 308 bears a traffic identifier of M. Consequently, frame 308 will be processed by first wireless communication station 302A and will not be processed by second wireless communication station 302B.

Referring back to FIG. 2, in accordance with some embodiments of the present invention, access point 104 (FIG. 1), rather than the requesting communication station, may assign a traffic stream identifier in operation 210. In operation 214, the access point may send a response message to the requesting wireless communication station indicating that the requested traffic stream has been added. The response may indicate the assigned traffic stream identifier that the wireless communication station should use to identify the requested data stream.

In operation 218, the requesting wireless communication device may use the traffic stream identifier to identify and process received packets of the requested stream transmitted by the access point.

In some embodiments, because the access point assigns traffic stream identifiers, the access point may ensure that other wireless communication stations wishing to receive the same multicast stream use the assign the same identifier to the stream. For example, assuming a second wireless communication station sends the access point an add traffic stream request identifying the same multicast group (e.g., per operation 202). In operation 206, the access point may determine that the multicast stream has already been admitted. Consequently, flow proceeds to operation 216. In operation 216, the access point replies to the second wireless communication station in the affirmative, indicating that the requested traffic stream is already admitted and informs the second wireless communication station to use a traffic stream identifier that the access point has already assigned. In these embodiments, both wireless communications stations may receive the requested traffic stream using the same traffic stream identifier allowing the access point to transmit each packet once, rather than twice, in this example. In these embodiments, bandwidth for a multicast traffic stream needs to be reserved only once, rather than for each requesting wireless communication station.

Although the individual operations of procedure 200 are illustrated and described as separate operations, one or more of the individual operations may be performed concurrently, and nothing requires that the operations be performed in the order illustrated.

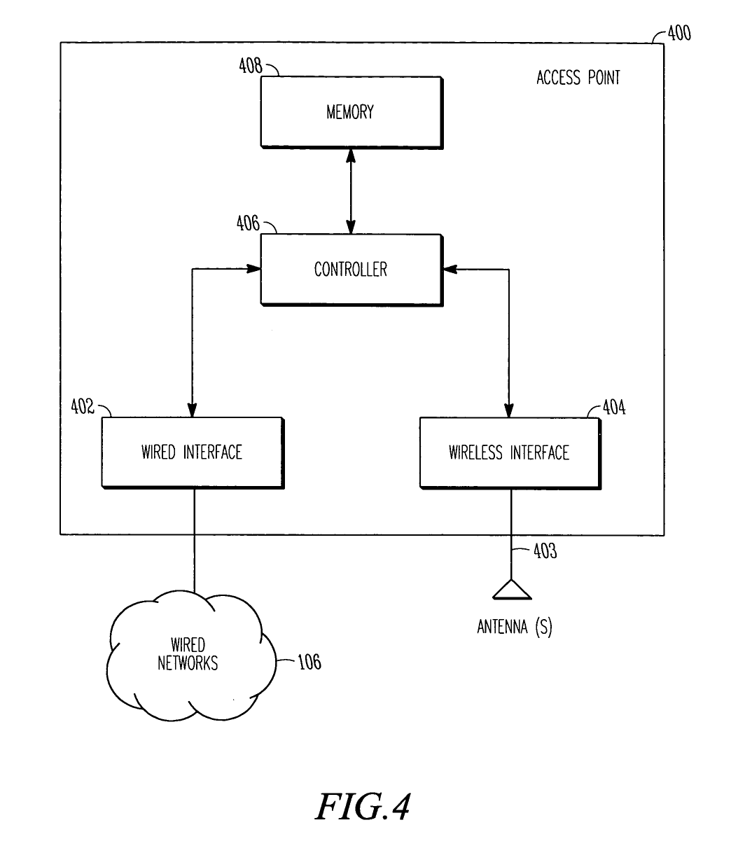

FIG. 4 is a block diagram of an access point in accordance with some embodiments of the present invention. Access point 400 may be suitable for use as access point 104 (FIG. 1), although other configurations may also be suitable. Access point 400 includes wired interface 402 and wireless interface 404. Wired interface 402 serves as an interface to wired network 406. In some embodiments, wired network 406 may correspond to wired network 106 (FIG. 1). In some embodiments, wired network 406 may be an IEEE 802.3-compliant network, although the scope of the invention is not limited in this respect. Antenna 403 may correspond to one or more of antennas 105 (FIG. 1). Each of interfaces 402 and 404 may be coupled to controller 406 that may execute instructions stored in memory 408, although the scope of the invention is not limited in this respect.

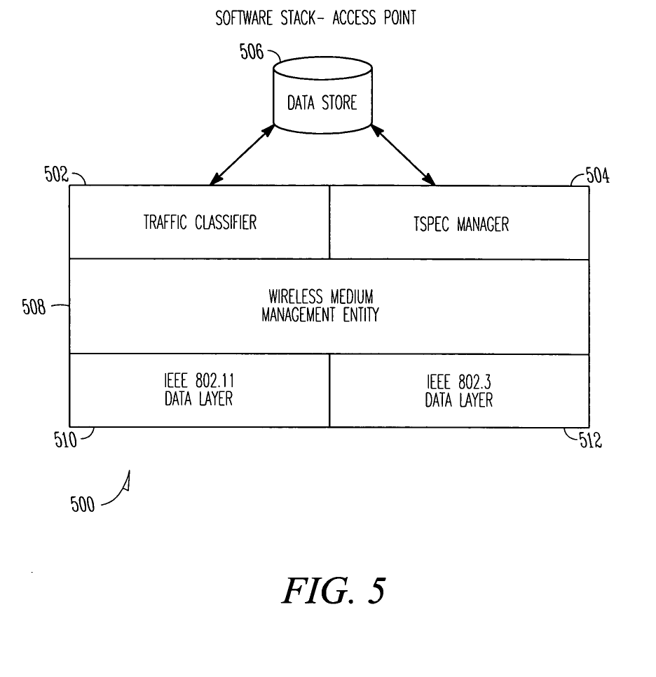

FIG. 5 illustrates a software stack suitable for use by an access point in accordance with some embodiments of the present invention. Software stack 500 may be stored in a memory unit, such memory 408 (FIG. 4) of access point 400 (FIG. 4) and may be executed by controller circuitry, such as controller 406 (FIG. 4), although the scope of the invention is not limited in this respect. Software stack 500 may include traffic classifier 502 and traffic specification (TSPEC) manager 504, each of which have access to data store 506. Traffic classifier 502 and TSPEC manager 504 may have access to an application interface (API) exposed by wireless medium management entity 508, which, in turn, has access to APIs exposed by data layers 510 and 512. In some embodiments, data layer 510 may be an IEEE 802.11 data layer and data layer 512 may be an IEEE 802.3 data layer, although the scope of the invention is not limited in this respect. A more detailed description of some of the operations performed by the various layers shown in FIG. 5 is provided below.

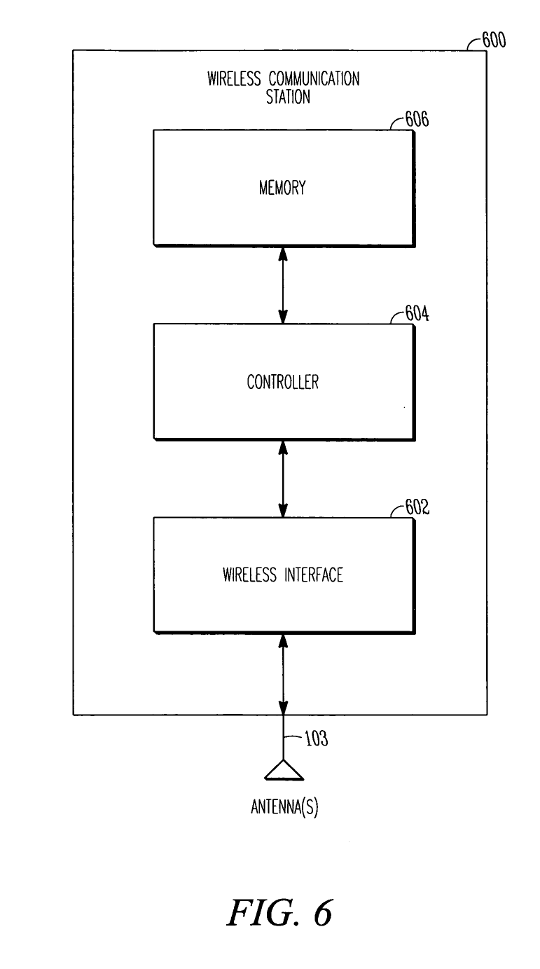

FIG. 6 is a block diagram of a wireless communication station in accordance with some embodiments of the present invention. Wireless communication station 600 may be suitable for use as one or more of wireless communication stations 102 (FIG. 1).Wireless communication station 600 includes wireless interface 602 for communicating radio-frequency (RF) signals using antenna 103 with an access point, such as access point 104 (FIG. 1). In some embodiments, wireless interface 602 may be a network interface card (NIC), although the scope of the invention is not limited in this respect. In some embodiments, wireless interface 602 may serve as an interface to an IEEE 802.11e-compliant wireless network, although the scope of the invention is not limited in this respect. Interface 602 may be coupled to controller 604 that may execute instructions stored in memory 606.

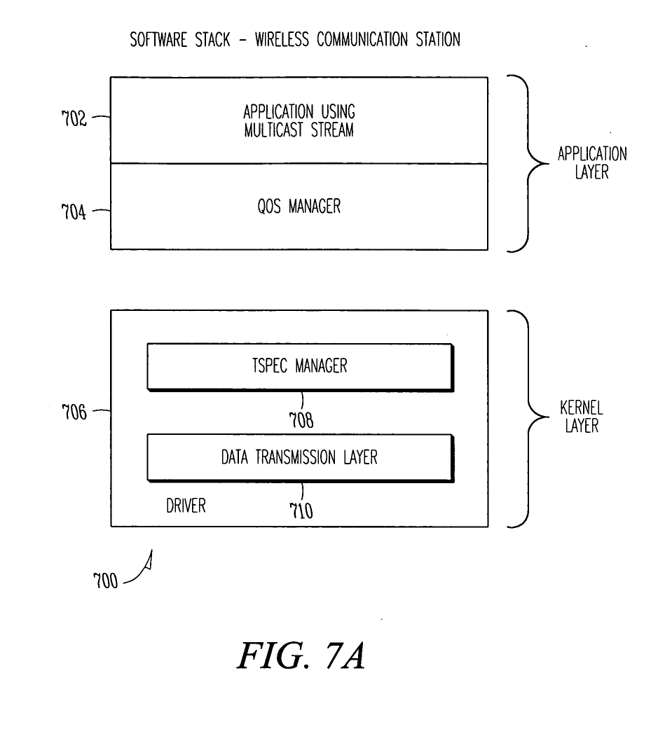

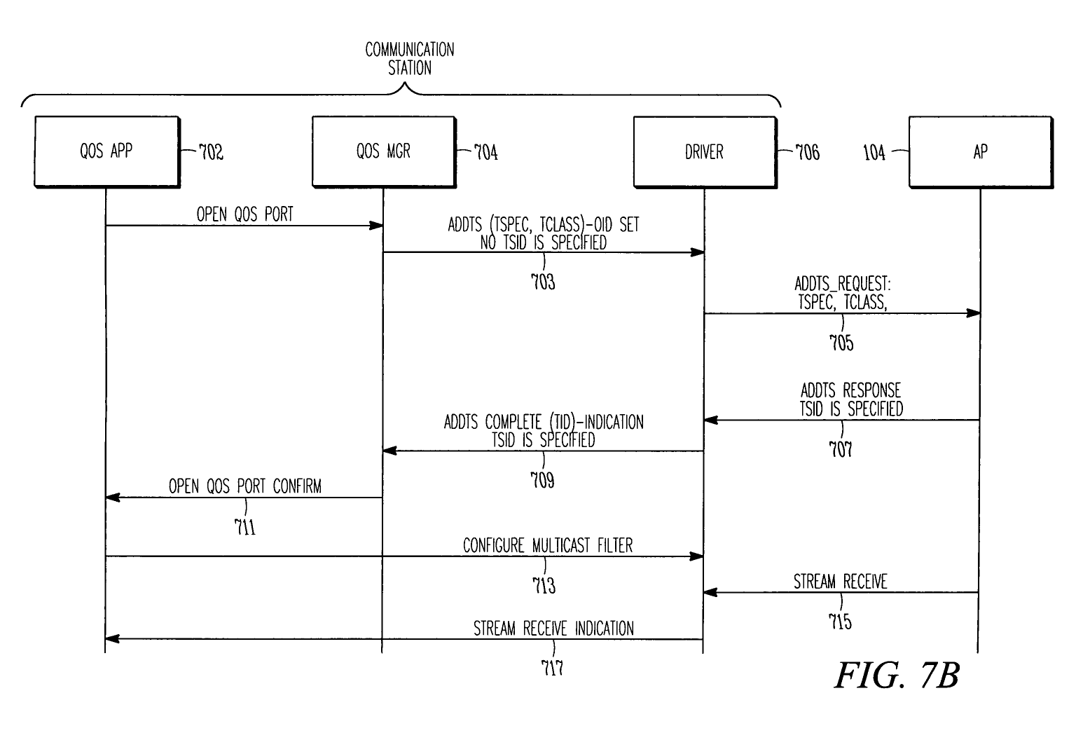

FIG. 7A illustrates a software stack suitable for use by a wireless communication station in accordance with some embodiments of the present invention. Software stack 700 may be stored in a memory unit, such as memory 606 (FIG. 6) of a wireless communication station and may be executed by controller circuitry, such as controller 604 (FIG. 6). Software stack 700 may include application 702 that may have access to an API exposed by QoS manager 704. QoS manager 704 may have access to an API exposed by driver 706, which may include TSPEC manager 708 and data transmission layer 710. In some embodiments, multicast application 702 and QoS manager 704 may be executed as an application or part of an application layer, while driver 706 may be executed as a kernel or as part of a kernel layer, although the scope of the invention is not limited in this respect. A more detailed description of the operations performed by the various layers of software stack 700 is provided below.

FIG. 7B illustrates a sequence of operations performed by a communication station and an access point for admission control of multicast downstream traffic in accordance with some embodiments of the present invention. In some embodiments, the operations illustrated in FIG. 7B may be performed by application (QoS APP) 702, QoS manager (QoS MGR) 704 and driver 706 that are part of software stack 700 (FIG. 7B) and access point 104 (FIG. 1). Some operations of procedure 200 (FIG. 2) may be illustrated in FIG. 7B.

In accordance with some embodiments, various operations of procedure 200 (FIG. 2) may be performed by wireless communication station 600 (FIG. 6) and access point 400 and may be carried out, respectively, by software stacks 500 (FIG. 5) and 700 (FIG. 7A). Examples of some of the various operations of procedure 200 (FIG. 2) is described below.

Referring to FIGS. 7A and 7B, application 702 may invoke the reception of a multicast data stream. For example, application 702 may be a program by which a multicast data stream, such as a video and/or audio stream, is presented to a user. In some embodiments, application 702 may be a QoS application, although the scope of the invention is not limited in this respect. In some embodiments, application 702 uses an API exposed by QoS manager 704 to request access point 104 (FIG. 1) to identify certain packets as belonging to a data stream, and to reserve bandwidth for handling the data stream. The request from the application may include information available to the application. For example, the request may include the IP address of the multicast source, the IP address of the multicast destination, and a description of the bandwidth required by application 702. In some embodiments, the multicast destination may include a class D address to which the IP packets are addressed, although the scope of the invention is not limited in this respect.

In response, QoS manager 704 may build the request to add a traffic stream. In performing this operation, QoS manager 704 may assemble a traffic specification element that may include a quantitative description of the bandwidth required by application 702. In some embodiments, a traffic specification element (e.g., TSPEC) may be built in accordance with IEEE 802.11e, although the scope of the invention is not limited in this respect. In some embodiments, the traffic specification element may include a description of minimum data rate, mean data rate, maximum jitter, and maximum delivery delay. The request may also include a traffic classification element. A traffic classification (TCLAS) element may convey information that the access point may use to determine whether a particular incoming packet belongs to a data stream. For example, the traffic classification element may include a source and destination IP address. As discussed below, the access point may parse an incoming frame to extract the source and destination IP addresses; if they match the addresses in the traffic classification, then the incoming frame belongs to the data stream associated with the traffic classification element. In some embodiments, the traffic classification element includes the MAC address. In some embodiments, the MAC address may be associated with a class D IP address (e.g., 00000001:00000000:01011110:0+the lower-order 23 bits of the class D destination IP address), although the scope of the invention is not limited in this respect.

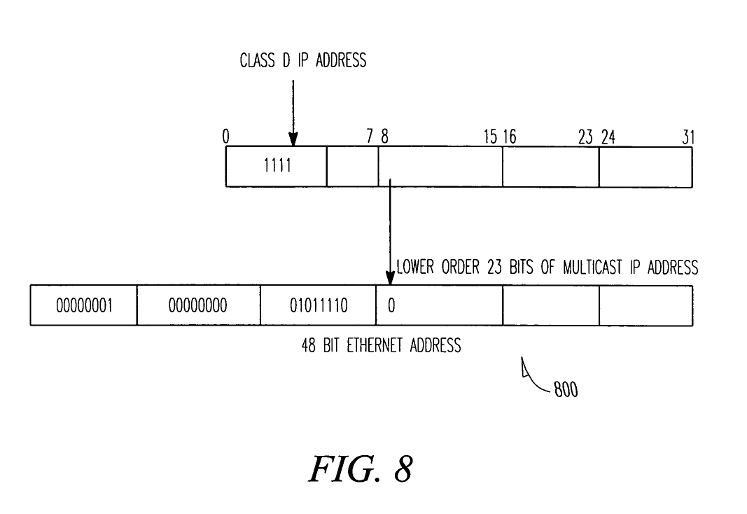

FIG. 8 illustrates assemblage of the MAC address in accordance with some embodiments of the present invention. In some embodiments, MAC address 800 may be a 48 bit Ethernet address, although the scope of the invention is not limited in this respect. In some embodiments, MAC address may be suitable for use in the traffic classification element described above.

Referring back to FIGS. 7A and 7B, after assembling the request, as described above, QoS manager 704 may use an API exposed by driver 706 to send the request to driver 706. This may be illustrated by communication 701 (FIG. 7B), which may include opening a QoS port, and communication 703 (FIG. 7B), which may include an add traffic stream (ADDTS) request with specification of the TSID. In response, driver 706 may build an ADDTS MAC frame and may forward the frame to data transmission layer 710. Data transmission layer 710 may send the add traffic stream MAC frame to network interface 602 (FIG. 6), and the frame may be transmitted to access point 104 (FIG. 1). This may be illustrated by communication 705 (FIG. 7B).

At access point 104 (FIG. 1), the add traffic stream MAC frame may be received by wireless interface 404 (FIG. 4) and may be passed to data layer 510 (FIG. 5). Thereafter, the frame may be passed to TSPEC manager 504. As mentioned above, TSPEC manager 504 may maintain data store 506. The organization (e.g., schema) of data store 506 is a matter of design choice. Generally, data store 506 may be used to relate one or more of traffic classification elements, traffic stream identifier, wireless communication station address, and a traffic specification. Thus, by querying data store 506 with a given traffic classification element, for example, TSPEC manager 504 may obtain the other information associated with the traffic classification element, such as the traffic stream identifier, the traffic specification, etc.

When TSPEC manager 504 receives the add traffic stream MAC frame, it may extract the traffic classification element(s) and may query data store 506. In response, TSPEC manager 504 may be informed whether any other wireless communication stations have already requested access point 104 (FIG. 1) to identify incoming frames bearing characteristics described by the traffic classification element(s) as being part of a data stream. If so, TSPEC manager 504 may obtain the traffic stream identifier already used to identify the data stream. Thereafter, TSPEC manager 504 may build a response message indicating that the requested traffic stream has been added and that the requesting wireless communication station should use the traffic stream identifier extracted from data store 506 when, for example, the traffic stream identifier is already assigned to the data stream. If, on the other hand, no other wireless communication stations have already requested access point 104 (FIG. 1) to identify incoming frames bearing characteristics described by the traffic classification element(s) as being part of a data stream, then TSPEC manager 504 may determine whether access point 104 (FIG. 1) has sufficient bandwidth available to service the requested data stream. If not, TSPEC manager 504 may build a response message indicating that the requested traffic stream will not be admitted. Alternatively, in some embodiments, TSPEC manager 504 may counter-propose the amount of bandwidth access point 104 (FIG. 1) can dedicate to the requested traffic stream. When TSPEC manager 504 determines that access point 104 (FIG. 1) has sufficient bandwidth to service the requested data stream, then TSPEC manager 504 may performs the following operations:

(1) TSPEC manager 504 may select a new traffic stream identifier for the traffic stream;

(2) TSPEC manager 504 may store the new traffic stream identifier, traffic classification element(s), traffic specification, and wireless communication station address in the data store 506; and

(3) TSPEC manager 504 may build a response message indicating that the requested traffic stream has been added and that the requesting wireless communication station should use the traffic stream identifier selected by TSPEC manager 504.

After building the response message (either having determined that the data stream already existed or that the data stream did not already exist), TSPEC manager 504 may send the response message to data layer 510 for transmission to the requesting wireless communication station. This may be illustrated by communication 707 (FIG. 7B).

The response frame may be received at the wireless communication station and may be passed from data transmission layer 710 (FIG. 7A) to TSPEC manager 708. This may be illustrated by communication 709 (FIG. 7B). When the response indicates that the data stream has been admitted, TSPEC manager 708 may extract information, including for example, the traffic stream identifier, from the response message and may store the extracted information in a data store. The wireless communication station may then use the traffic stream identifier assigned by the access point and embedded in the response frame. TSPEC manager 708 may notify QoS manager 704 that the data stream has been successfully admitted and QoS manager 704 may relay the information to application 702. This may be illustrated by communication 711 (FIG. 7B).

In response to being notified of the successful admission of the requested data stream, application 702 may request driver 706 to update its multicast filter to permit passage of frames bearing an address corresponding to the IP address of the admitted multicast frame. In some embodiments, the multicast filter may be a MAC filter that may be updated to permit passage of MAC frames bearing a MAC address corresponding to a class D IP address of the admitted multicast frame. This may be illustrated by communication 713 (FIG. 7B). For example, the MAC filter may be updated to admit MAC frames having a MAC address of 00000001:00000000:01011110:0+the lower-order 23 bits of the class D destination IP address, although the scope of the invention is not limited in this respect. The MAC filtering functionality may occur in driver 706 or may be performed by a network interface. In some embodiments, application 702 may conclude the process by sending a message to the multicast server requesting the server to begin its multicast transmission.

After the data stream has been admitted, access point 104 (FIG. 1) may respond to the reception of a frame belonging to the admitted data stream as follows. In some embodiments, the frame of the admitted data stream may be received via data layer 512 (FIG. 5) and passed to wireless medium management entity 508 (FIG. 5). In response, wireless medium management entity 508 (FIG. 5) may identify the admitted data stream frame as a multicast frame and may pass the frame to traffic classifier 502 (FIG. 5).

In some embodiments, upon receiving the admitted data stream frame, traffic classifier 502 (FIG. 5) may parse the frame removing address information, such as the MAC frame destination address, the MAC frame source address, the IP destination address, and IP source address, although the scope of the invention is not limited in this respect. Traffic classifier 502 (FIG. 5) may query data store 506 (FIG. 5) with the extracted information to determine if it matches any traffic classification elements stored therein. If the extracted address information matches a traffic classification element, then it is known that the MAC frame belongs to the traffic stream associated with the traffic classification element. By querying data store 506 (FIG. 5), traffic classifier 502 (FIG. 5) may obtain the traffic stream identifier associated with the data stream to which the frame belongs. Traffic classifier 502 (FIG. 5) may insert the traffic stream identifier into the MAC header and may pass the frame to wireless medium management entity 508 (FIG. 5). In some embodiments, wireless management medium entity 508 (FIG. 5) may insert data into the remainder of the MAC frame header (including, for example, inserting the MAC address corresponding to the class D IP address into the MAC frame header), and may passes the frame to data layer 510 (FIG. 5) for transmission to one or more of wireless communication stations 102 (FIG. 1). This may be illustrated by communications 715 and 717 (FIG. 7B).

When an application running on a particular wireless communication station wishes to stop receiving a multicast transmission, it may send a delete the traffic stream command. In response to the deletion of the traffic stream command, TSPEC manager 504 (FIG. 5) may remove the address of the wireless communication station from association with the data stream. If after such removal no other wireless addresses remain (i.e., the last wireless communication station has requested deletion of the stream), TSPEC manager 504 may remove the data stream entry from data store 506 (FIG. 5).

Although access point 300 (FIG. 3), software stack 400 (FIG. 4), wireless communication station 600 (FIG. 6) and software stack 700 (FIG. 7A) are illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), and combinations of various hardware and logic circuitry for performing at least the functions described herein. In some embodiments, the functional elements of one or more of either access point 300 (FIG. 3), software stack 400 (FIG. 4), wireless communication station 600 (FIG. 6) and software stack 700 (FIG. 7A) may refer to one or more processes operating on one or more processing elements.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, computing device includes one or more processing elements coupled with computer-readable memory that may be volatile or non-volatile memory or a combination thereof.

Embodiments of the invention may be implemented in one or a combination of hardware, firmware and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus the following claims are hereby incorporated into the detailed description, with each claim standing on its own as a separate preferred embodiment.

What is claimed is:

1. A method for receiving multicast traffic comprising:
sending a request to a managing wireless communication station to receive a multicast traffic stream;
receiving a response to the request including either a new or an existing traffic stream identifier; and
using the traffic stream identifier to receive packets of the requested multicast traffic stream, the managing wireless communication station to transmit the existing traffic stream identifier in the response when the multicast traffic stream is currently admitted by the managing wireless communication station.

2. The method of claim 1 wherein the sending, receiving, and using are performed by a first wireless communication station,
wherein the managing wireless communication station identifies the existing traffic stream identifier when the multicast traffic stream is currently admitted by the managing wireless communication station for transmission to a second wireless communication station,
wherein the managing wireless communication station assigns the new traffic stream identifier to the requested multicast traffic stream when the multicast traffic stream is not currently admitted by the managing wireless communication station, and
wherein the managing wireless communication station sends the new traffic stream identifier in the response after assigning the new traffic stream identifier.

3. The method of claim 2 wherein when the managing wireless communication station assigns the new traffic stream identifier, the managing wireless communication station reserves additional downlink bandwidth for transmission of the requested multicast traffic stream, and
wherein when the managing wireless communication station transmits the existing traffic stream identifier in the response, the managing wireless communication station refrains from reserving the additional downlink bandwidth for transmission of the requested multicast traffic stream.

4. The method of claim 3 wherein the request includes a traffic specification that includes quantitative objectives for delivery of the requested traffic stream.

5. The method of claim 4 wherein the quantitative objectives include at least one of minimum data rate, mean data rate, maximum jitter, or maximum delivery delay for the requested multicast traffic stream.

6. The method of claim 2 wherein the request further includes a traffic classification element identifying a multicast address as a destination address, the multicast address being a medium access control address, and
wherein the method further comprises configuring a medium access control filter to receive frames bearing the medium access control address corresponding to the multicast address.

7. The method of claim 1 further comprising receiving packets of the requested multicast traffic stream using either the new or the existing traffic stream identifier provided by the managing wireless communication station, the packets being received over a multicarrier communication channel comprising a plurality of substantially orthogonal frequency division multiplexed (OFDM) subcarriers.

8. The method of claim 7 wherein more than one wireless communication station receives the packets of the multicast traffic stream using the same traffic stream identifier assigned by the managing wireless communication station, and
wherein the multicast traffic stream comprises one of an audio stream, a video stream and an audio-visual stream.

9. A wireless communication device comprising:
interface circuitry to send a request to a managing wireless communication station to receive a multicast traffic stream and to receive a response to the request, the response including either a new or an existing traffic stream identifier; and
processing circuitry to use the received traffic stream identifier to receive packets of the requested multicast traffic stream, the managing wireless communication station to transmit the existing traffic stream identifier in the response when the multicast traffic stream is currently admitted by the managing wireless communication station for transmission to another wireless communication device.

10. The wireless communication device of claim 9 wherein the managing wireless communication station assigns the new traffic stream identifier to the requested multicast traffic stream when the multicast traffic stream is not currently admitted by the managing wireless communication station, and
wherein the managing wireless communication station sends the new traffic stream identifier to the wireless communication device in response to the request.

11. The wireless communication device of claim 10 wherein when the managing wireless communication station assigns the new traffic stream identifier, the managing wireless communication station reserves additional downlink bandwidth for transmission of the requested multicast traffic stream, and
wherein when the managing wireless communication station transmits the existing traffic stream identifier in the response, the managing wireless communication station refrains from reserving the additional downlink bandwidth for transmission of the requested multicast traffic stream.

12. The wireless communication device of claim 11 wherein the processing circuitry includes a traffic specification that includes quantitative objectives for delivery of the requested traffic stream in the request.

13. The wireless communication device of claim 12 wherein the quantitative objectives include at least one of minimum data rate, mean data rate, maximum jitter, or maximum delivery delay for the requested multicast traffic stream.

14. The wireless communication device of claim 10 wherein the processing circuitry further includes a traffic classification element in the request identifying a multicast address as a destination address, the multicast address being a medium access control address, and
wherein the wireless communication device further comprises a medium access control filter to receive frames bearing the medium access control address corresponding to the multicast address.

15. The wireless communication device of claim 10 wherein the wireless interface receives packets of the requested multicast traffic stream using either the new or the existing traffic stream identifier provided by the managing wireless communication station, the packets being received over a multicarrier communication channel comprising a plurality of substantially orthogonal frequency division multiplexed (OFDM) subcarriers.

16. The wireless communication device of claim 10 wherein more than one receiving wireless communication stations receive the packets of the multicast traffic stream using the same traffic stream identifier assigned by the managing wireless communication station, and
wherein the multicast traffic stream comprises one of an audio stream, a video stream or an audio-visual stream.

17. A method of providing multicast traffic in a wireless network comprising:
receiving a request to add a multicast traffic stream from a wireless communication station;
identifying an existing traffic stream identifier when the multicast traffic stream is currently admitted;
assigning a new traffic stream identifier when the multicast traffic stream is not currently admitted; and
sending a response to the wireless communication station, the response including either the existing or the new traffic stream identifier.

18. The method of claim 17 wherein when the new traffic stream identifier is assigned, the method further comprises reserving additional downlink bandwidth for transmission of the requested multicast traffic stream, and
wherein when the existing traffic stream identifier is identified, the method further comprises refraining from reserving additional downlink bandwidth for transmission of the requested multicast traffic stream.

19. The method of claim 17 wherein the request includes a traffic specification, and wherein the traffic specification includes quantitative objectives for delivery of the requested traffic stream.

20. The method of claim 17 further comprising determining whether sufficient bandwidth exists to service the traffic stream according to the quantitative objectives when the requested multicast traffic stream is not currently admitted.

21. The method of claim 17 further comprising transmitting packets of the requested multicast traffic stream using either the new or the existing traffic stream identifier, the packets being transmitted over a multicarrier communication channel comprising a plurality of substantially orthogonal frequency division multiplexed (OFDM) subcarriers.

22. The method of claim 17 wherein when the multicast traffic stream is currently admitted, more than one receiving wireless communication station receives the packets of the multicast traffic stream using the existing traffic stream identifier provided by the managing wireless communication station, and
wherein the multicast traffic stream comprises one of an audio stream, a video stream or an audio-visual stream.

23. A managing wireless communication station comprising:
a wireless interface to receive a request to add a multicast traffic stream from a wireless communication station; and
processing circuitry to identify an existing traffic stream identifier when the multicast traffic stream is currently admitted and to assign a new traffic stream identifier when the multicast traffic stream is not currently admitted,
the wireless interface to transmit a response to the wireless communication station including either the existing or the new traffic stream identifier.

24. The managing wireless communication station of claim 23 wherein when the new traffic stream identifier is assigned, the processing circuitry reserves additional downlink bandwidth for transmission of the requested multicast traffic stream, and
wherein when the existing traffic stream identifier is transmitted, the processing circuitry refrains from reserving additional downlink bandwidth for transmission of the requested multicast traffic stream.

25. The managing wireless communication station of claim 23 wherein the request includes a traffic specification, and
wherein the traffic specification includes quantitative objectives for delivery of the requested traffic stream.

26. The managing wireless communication station of claim 23 wherein the processing circuitry determines whether sufficient bandwidth exists to service the traffic stream according to the quantitative objectives when the requested multicast traffic stream is not currently admitted.

27. The managing wireless communication station of claim 23 wherein the wireless interface is configured to transmit packets of the requested multicast traffic stream using either the new or the existing traffic stream identifier, the packets being transmitted over a multicarrier communication channel comprising a plurality of substantially orthogonal frequency division multiplexed (OFDM) subcarriers.

28. The managing wireless communication station of claim 23 wherein when the multicast traffic stream is currently admitted, more than one receiving wireless communication station receives the packets of the multicast traffic stream using the existing traffic stream identifier provided by the managing wireless communication station, and
wherein the multicast traffic stream comprises one of an audio stream, a video stream or an audio-visual stream.

29. A wireless communication system comprising:
interface circuitry to send a request to a managing wireless communication station to receive a multicast traffic stream and to receive a response to the request, the response including either a new or an existing traffic stream identifier;
processing circuitry to use the received traffic stream identifier to receive packets of the requested multicast traffic stream, the managing wireless communication station to transmit the existing traffic stream identifier in the response when the multicast traffic stream is currently admitted by the managing wireless communication station; and
a substantially omnidirectional antenna for use by the interface circuitry in sending the request, receiving the response and receiving packets of the multicast traffic stream.

30. The system of claim 29 wherein the managing wireless communication station assigns the new traffic stream identifier to the requested multicast traffic stream when the multicast traffic stream is not currently admitted by the managing wireless communication station, and
wherein the managing wireless communication station transmits the new traffic stream identifier in the response to the system in response to the request after assigning the new traffic stream identifier.

31. The system of claim 30 wherein when the managing wireless communication station assigns the new traffic stream identifier, the managing wireless communication station reserves additional downlink bandwidth for transmission of the requested multicast traffic stream, and
wherein when the managing wireless communication station transmits the existing traffic stream identifier, the managing wireless communication station refrains from reserving additional downlink bandwidth for transmission of the requested multicast traffic stream.

32. The system of claim 30 wherein the processing circuitry further includes a traffic classification element in the request identifying a multicast address as a destination address, the multicast address being a medium access control address, and
wherein the system further comprises a medium access control filter to receive frames bearing the medium access control address corresponding to the multicast address.

33. The system of claim 30 wherein the wireless interface receives packets of the requested multicast traffic stream using either the new or the existing traffic stream identifier provided by the managing wireless communication station, the packets being received over a multicarrier communication channel comprising a plurality of substantially orthogonal frequency division multiplexed (OFDM) subcarriers,
wherein more than one receiving wireless communication station receives the packets of the multicast traffic stream using the same traffic stream identifier assigned by the managing wireless communication station, and
wherein the multicast traffic stream comprises one of an audio stream, a video stream or an audio-visual stream.

34. A machine-accessible medium that provides instructions, which when accessed, cause a machine to perform operations comprising:
sending a request to a managing wireless communication station to receive a multicast traffic stream;
receiving a response to the request, the response including either a new or an existing traffic stream identifier; and
using the traffic stream identifier to receive packets of the requested multicast traffic stream, the managing wireless communication station to transmit the existing traffic stream identifier in the response when the multicast traffic stream is currently admitted by the managing wireless communication station.

35. The machine-accessible medium of claim 34 wherein the instructions, when further accessed cause the machine to perform operations wherein the managing wireless communication station assigns the new traffic stream identifier to the requested multicast traffic stream when the multicast traffic stream is not currently admitted by the managing wireless communication station, and
wherein the managing wireless communication station transmits the new traffic stream identifier in the response.

36. The machine-accessible medium of claim 35 wherein the instructions, when further accessed cause the machine to perform operations wherein when the managing wireless communication station assigns the new traffic stream identifier, the managing wireless communication station reserves additional downlink bandwidth for transmission of the requested multicast traffic stream, and
wherein when the managing wireless communication station assigns the existing traffic stream identifier, the managing wireless communication station refrains from reserving additional downlink bandwidth for transmission of the requested multicast traffic stream.

37. The machine-accessible medium of claim 35 wherein the instructions, when further accessed cause the machine to perform operations wherein the request further includes a traffic classification element identifying a multicast address as a destination address, the multicast address being a medium access control address, and
wherein the operations further comprise configuring a medium access control filter to receive frames bearing the medium access control address corresponding to the multicast address.

38. The machine-accessible medium of claim 35 wherein the instructions, when further accessed cause the machine to perform operations further comprising receiving packets of the requested multicast traffic stream using either the new or the existing traffic stream identifier provided by the managing wireless communication station, the packets being received over a multicarrier communication channel comprising a plurality of substantially orthogonal frequency division multiplexed (OFDM) subcarriers,
wherein more than one receiving wireless communication station receives the packets of the multicast traffic stream using the same traffic stream identifier assigned by the managing wireless communication station, and
wherein the multicast traffic stream comprises one of an audio stream, a video stream or an audio-visual stream.
